(19) United States
(12) Patent Application Publication
(10) Pub. No.: US 2018/0228196 A1
(43) Pub. Date: Aug. 16, 2018

(54) HIGH-ENERGY AND PROTEIN-ENRICHED NUTRITIONAL COMPOSITION

(71) Applicant: EVEN SANTE INDUSTRIE, Lesneven (FR)

(72) Inventors: Audrey Le Fur, Bourg Blanc (FR); Jean-Marc Le Palud, Plabennec (FR); Anne Fosseux, Brest (FR)

(21) Appl. No.: 15/750,314

(22) PCT Filed: Aug. 8, 2016
(86) PCT No.: PCT/FR2016/052053

§ 371 Date: Feb. 5, 2018

(30) Foreign Application Priority Data
Aug. 7, 2015 (FR) 1557603

(51) Int. Cl. A23L 33/19; A23L 33/125; A23L 33/115; A23L 33/00; A23L 2/66

(52) U.S. Cl. CPC A23L 33/19; A23L 33/125; A23V 2002/00; A23L 33/40; A23L 2/66; A23L 33/115

(57) ABSTRACT

This application relates to a high-protein and high-calorie, ready-to-use, heat-sterilized, oral enteral nutritional composition.

### CROSS-REFERENCE TO RELATED APPLICATIONS

This application is a national phase entry under 35 U.S.C. § 371 of International Patent Application PCT/FR2016/052053, filed Aug. 8, 2016, designating the United States of America and published as International Patent Publication WO 2017/025688 A1 on Feb. 16, 2017, which claims the benefit under Article 8 of the Patent Cooperation Treaty to French Patent Application Serial No. 1557603, filed Aug. 7, 2015.

### TECHNICAL FIELD

This application relates to the field of high-energy and protein-enriched nutritional compositions for special medical purposes. Such nutritional compositions are intended for elderly persons, sick persons or persons in a weakened condition or malnourished due to illness. Such compositions are used as the main source of food or as a food supplement.

This application specifically relates to a high-energy and protein-enriched oral nutritional composition, which is time stable, single-dose and ready-to-use. The composition according to the invention is intended for adults and can be used as the main source of food or as a food supplement.

### BACKGROUND

The human body is a complex organism. Life support requires energy that is supplied by food.

Food provides measurable energy as kilojoules or kilocalories.

The correct functions of the body require sufficient and balanced food. Energy has to be provided by proteins, sugars and fats. Proteins are essential for muscle activity. Fat makes it possible to store energy released according to the needs of the body, and sugars provide a readily available energy source. Such sources of calories are thus complementary. They must be supplemented with the intake of vitamins and minerals, which are involved in the physiological balance of the various vital functions of the body.

Such balance can be disturbed in case of malnutrition due, for example, to eating disorder (anorexia, . . . ), or malnutrition resulting from a pathological situation or in elderly people who may no longer have a correct diet by themselves.

Nutritional requirements change throughout life. For example, elderly people have reduced requirements in fat, due to a reduction of activity and a slowing down of cell renewal.

Some people, for example due to illness, are no longer able to eat properly or even to feed at all. It is, therefore, necessary to give them supplementation food or substitute food to meet their nutritional requirements.

When the digestive tract is still functional, enteral nutrition is preferred. It can be done with nutritional compositions suitable in terms of nutritional profile, viscosity or volume.

For example, some patients cannot ingest large amounts of food. These may be, for example, cachectic patients as a result of some pathology, or not, for example, acquired immunodeficiency syndrome, cancer, respiratory or infectious diseases, or trauma.

High-protein and high-energy products are available, the protein concentration of which is at least equal to or greater than 10 grams (g) per 100 milliliters (mL) of the composition. These include:
FORTIMEL PROTEIN marketed by NUTRICIA. It comprises 240 kcal per 100 mL and 14.4 g of protein per 100 mL of the composition; and
RENUTRYL BOOSTER marketed by NESTLE HEALTH SCIENCE. This product comprises 200 kilocalories (kcal) per 100 mL and 10 g of proteins per 100 mL of the composition.

International Patent Application Publication No. WO2011/152706 discloses a pre-thickened compact liquid nutritional composition. More specifically, the liquid enteral nutritional composition has a caloric density between 1.0 and 4.0 kcal/mL, a viscosity between 150 and 1,800 mPa·s, measured at a shear rate of 50/seconds at 20° C., comprising digestible carbohydrates and fat. The composition further comprises at least one of (a1) between 8-20 g of proteins per 100 mL of the composition, with the micellar casein representing at least 50% by weight of the total protein content of the composition, or (a2) between 16% and 45% of protein energy, with the micellar casein representing at least 50% of the caloric content of the proteins; and (b) anionic fibers capable of sequestering calcium, and (c) carrageenan between 0.015 g and 0.25 g per 100 mL of the composition. The invention also relates to its use for preventing/treating dysphagia and/or treating/preventing malnourishment or undernourishment associated with dysphagia.

International Patent Application Publication No. WO2014/099795 discloses a composition for oral nutrition with low viscosity and high caloric density. The composition according to this patent comprises between 8 and 27 g of proteins per 100 mL of the composition, caloric density ranging from 200 to 300 kcal per 100 mL of the composition, viscosity of 45-145 cps and a combined amount of fat and proteins ranging from 8 to 27 g per 100 mL of the composition.

International Patent Application Publication No. WO2007/108827 discloses a nutritional supplement comprising a protein source of the MPI or canola protein type, but without caseinates, with the amount of protein ranging from 6.75 to 12.65 g of proteins per 100 mL of the composition, a caloric density of 2.25 to 3.25 calories per mL and a viscosity of less than 120 cps.

Oral enteral nutritional compositions with a complete or near-complete nutritional profile have an upper limit for the amount of proteins of approximately 14 g per 100 mL of the composition and a caloric density of 240 kcal per 100 mL.

There is a need to densify the nutritional profile of such compositions in order to reduce the volume ingested, while maintaining a sufficient fluidity of the composition to make it oral, or increasing the essential nutrients such as proteins, fat and sugars that causes an increase in viscosity, in particular, by increasing the solids content, which makes the formulation and industrial implementation particularly complex. The higher the solids content, the less water is available to disperse the pulverulent ingredients. Thus, when the solids content is particularly high, ingredients incorporation, dispersion, solubilization and hydration problems may occur, resulting, among other things, in too high viscosity, stability and altered organoleptic properties problems. Sterilization problems may also be encountered.

It is particularly difficult to formulate an enteral nutritional composition even richer in energy with an amount above 14 g of proteins per 100 mL of the composition while still having a sufficiently low viscosity to be oral. To be an oral composition, the viscosity of the composition should be less than 600 mPa·s when measured at 100 s⁻¹ using a rotary viscometer at 20° C.

### BRIEF SUMMARY

The present disclosure overcomes the drawbacks of the prior art by providing a ready-to-use, heat-sterilized, oral enteral nutritional composition including:
between 14 g and 20 g of proteins per 100 mL of the composition;
a caloric density ranging from 1,046 to 1,465 kJ (250 to 350 kcal) per 100 mL of the composition;
a combined amount of fat, carbohydrates and proteins ranging from 45 to 72 g per 100 mL of the composition;
a solids content ranging from 40% to 65% by weight of the composition; and
an amount of water not exceeding 65% by weight of the composition.

The combined amount of fat, carbohydrates and proteins advantageously ranges from 45 g to 65 g per 100 mL of the composition.

The solids content advantageously ranges from 40% to 60% by weight of the composition.

The proteins advantageously provide at least 20% of the total energy intake.

The carbohydrates provide from 20% to 50% of the total energy intake.

Fat provides from 30% to 65% of the total energy intake.

According to one embodiment, the viscosity of the composition after heat sterilization ranges from 100 mPa·s to 600 mPa·s when measured at 20° C. at 100 s⁻¹ using a rotary viscometer.

According to another embodiment, the viscosity of the composition after heat sterilization ranges from 100 mPa·s to 450 mPa·s when measured at 20° C. at 100 s⁻¹ using a rotary viscometer.

According to one embodiment, the caloric density of the composition preferably ranges from 1,046 kJ to 1,256 kJ (250 kcal to 300 kcal) per 100 mL of the composition.

The protein advantageously comprises at least one source of casein and serum proteins.

The source of casein is selected from the list of ingredients consisting of MPIs, MPCs, MCIs, proteins of liquid condensed milk, skim milk, condensed skim milk, sodium caseinates, potassium caseinates, calcium caseinates or a mixture of at least two of the same.

The composition advantageously comprises less than 10% by weight of serum proteins based on the weight of the total protein.

According to one embodiment, at least 60% by weight of the carbohydrates based on the weight of the total carbohydrate content are provided by glucose syrup having a DE ranging from 20 to 40.

According to one embodiment, the oral enteral nutritional composition comprises:
from 14 g to 14.5 g of proteins per 100 mL of the composition;
about 1,046 kJ (250 kcal) per 100 mL of the composition;
a combined amount of fat, carbohydrates and proteins ranging from 45 g to 46 g per 100 mL of the composition;
a solids content ranging from 40% to 44.5% by weight of the composition;
an amount of water of less than 60% by weight of the composition; and
viscosity of less than 450 mPa·s when measured at 20° C. at 100 s⁻¹ using a rotary viscometer.

The oral enteral nutritional composition is advantageously intended to feed an elderly person, a malnourished person, a convalescent person or a person suffering from a chronic disease.

### DETAILED DESCRIPTION

### Definitions

“Oral” according to this disclosure, means that the nutritional composition is sufficiently fluid to be drunk from a glass or using a straw. It does not require being administered with a spoon. The composition of this disclosure is not intended for administration with a feeding tube. The viscosity of an “oral” composition according to this disclosure is less than 600 mPa·s when measured at 100 s⁻¹, at 20° C., using a rotary viscometer. The rotary viscometer is of the cup and bob type, for example, a DIN coaxial cylinder. The viscosity preferably ranges from 100 mPa·s to 600 mPa·s, more preferably from 100 mPa·s to 450 mPa·s.

“Heat-sterilized” means that the composition, prior to packaging, is sterilized using techniques well known to the persons skilled in the art such as pasteurization and/or sterilization. The composition is preferably heat-sterilized before packaging.

“Ready-to-use” means that the heat-sterilized composition is packaged in a bottle, a pack, a small carton or any other packaging. The composition is packaged in single-dose size, typically of 50, 100, 125, 150, 200, 250 or 300 mL, preferably 125 mL. The thus packaged composition is shelf-stable, i.e., the use-before date (UBD) is at least 6 months, preferably at least 9 months, more preferably at least 12 months.

“At least” means the open interval includes the starting value of the interval, or the maximum value in the range in the case of “less than.”

### The Proteins:

The oral enteral nutritional composition comprises from 14 grams to 20 grams protein per 100 mL of the composition. The composition preferably comprises from 14 g to 19 g of proteins per 100 mL, even more preferably, from 14 g to 18 g of proteins per 100 mL of the composition. The protein comprises at least one source of casein and serum proteins (whey). The protein may include another source of animal or vegetable protein. The composition preferably comprises one milk protein source only, provided by cow's milk or the derivatives thereof.

Casein is supplied by various ingredients that are not restrictively Milk Protein Isolates (MPI), Milk Protein Concentrates (MPC), Micellar Casein Isolates (MCI), liquid condensed milk proteins, skim milk, condensed skim milk, sodium caseinates, potassium caseinates, calcium caseinates or a mixture of at least two of the same. In one particular, nevertheless preferred, embodiment, the protein includes no calcium caseinate ingredient.

The oral enteral nutritional composition comprises less than 10% by weight of serum proteins based on the weight of the total protein. Serum proteins, i.e., whey proteins, not only can be supplied by the total milk proteins—the sources of casein—but also by serum protein isolates and/or serum proteins concentrates. In a particular embodiment, serum proteins are supplied by the total milk proteins only, i.e., the source(s) of casein. The composition preferably comprises less than 8% of serum proteins based on the weight of the total protein, more preferably less than 7%, still more preferably less than 6%.

In one embodiment, the proteins provide at least 20% of the total energy intake (TEI). In one preferred embodiment, proteins supply 20% to 50% of the TEI.

### Carbohydrates:

The oral enteral nutritional composition advantageously comprises carbohydrates. Carbohydrates supply from 20% to 50% of the total energy intake.

Carbohydrates can be simple or complex carbohydrates or a mixture thereof. Carbohydrates can include glucose, fructose, sucrose, lactose, trehalose, palatinose, corn syrup, malt, maltose, isomaltose, partially hydrolyzed corn starch, maltodextrins, glucose syrup, sugar, oligosaccharides, polysaccharides, sweeteners or a mixture thereof. Carbohydrates are chosen so as to limit the impact thereof on the viscosity of the nutritional composition and to avoid excessive sweetness, Maillard's reactions and too high osmolarity.

At least 60% of carbohydrates based on the weight of the total carbohydrates are preferably supplied by glucose syrup having a DE (dextrose equivalent) between 20 and 40. Even more preferably, at least 70% of carbohydrates based on the weight of the total carbohydrates are supplied by glucose syrup having a DE (dextrose equivalent) between 20 and 40. Glucose syrup with a DE above 40 would result in a too sweet taste. Conversely, glucose syrup with too low a DE would cause an excessive increase in the viscosity of the finished product. This is the reason why maltodextrins having a DE of less than 20 are avoided in the formulation of the enteral nutritional composition according to the disclosure. A correct balance between viscosity and sweetness has thus surprisingly been found and disclosed herein.

In one particular embodiment, glucose syrup is associated with another source of carbohydrate.

In one embodiment, at least 60% of the carbohydrates based on the weight of the total carbohydrates are supplied by glucose syrup having a DE (dextrose equivalent) between 20 and 40, preferably between 20 and 35, even more preferably between 25 and 35.

### Fat:

The oral enteral nutritional composition advantageously further comprises lipids, which supply from 30% to 65% of the total energy intake.

The composition according to the disclosure comprises from 8 g to 30 g of fat per 100 mL of the composition.

The fat used in the composition of dietary fat has an animal or a plant origin. In one embodiment of the disclosure, vegetable oils such as canola, soybean, palm, corn, or sunflower oils or a mixture thereof, are preferred for their lower cholesterol and/or saturated fat content as compared to fat of animal origin.

The combined amount of fat, carbohydrates and proteins according to the composition of the present disclosure ranges from 45 g to 72 g per 100 mL of the composition. The combined amount of fat, carbohydrates and proteins of the composition preferably ranges from 45 g to 65 g per 100 mL of the composition, more preferably from 45 to 50 g per 100 mL of the composition.

### Vitamins and Minerals:

The nutritional composition according to the disclosure includes a wide variety of minerals and vitamins to be as close as possible to the recommended daily intake. In one embodiment of the disclosure, the nutritional composition has a complete or near-complete nutritional profile with regard to vitamins and minerals according to the European regulation on dietary foods for special medical purposes.

At least 15% of the recommended daily intake of vitamins and minerals, as set by the European legislation, are supplied.

### Preparation Method and Packaging:

The composition according to this disclosure can be obtained by preparing an aqueous phase wherein water, carbohydrates, proteins, minerals, vitamins, colorants, flavors and any other additive are incorporated successively in one or more step(s). Water is previously heated between 40° C. and 60° C. Then a fatty phase containing oils and/or emulsifiers is also heated and incorporated into the aqueous phase.

A cooling and balancing phase is applied and then the composition is sterilized prior to the aseptic packaging. Homogenization may be performed before or after sterilization.

Sterilization is made by heating according to the usual Ultra High Temperature processes.

### Examples

The disclosure will be better understood in light of the non-limiting examples. These examples relate to nutritionally complete or near-complete high-protein and high-calorie drinks. The compositions can be used as the sole source of nutrition or as a supplement. These are oral supplements belonging to the category of dietary foods for special medical purposes, and are intended to cover the nutritional needs in case of malnutrition caused by illness. They comply with the current legislation on medical nutrition products.

The compositions in the examples are vanilla flavored. Of course, they can be flavored with any other flavor such as chocolate, coffee, strawberry, raspberry, lemon, etc.

The nutritional compositions are sterilized here by UHT (Ultra High Temperature), which makes it possible to have a sterilizing value of 15 minutes.

The compositions are ready to use and packaged in suitable bottles of 125 mL, which corresponds to one serving.

These compositions can be drunk using a straw or from a glass.

Compositions containing 14 g (Example A), 14.4 g (Example D), 16 g (Example B) and 18 g (Example C) of proteins per 100 mL of the composition have been produced. Their viscosity is less than 600 mPa·s, or even less than 450 mPa·s when measured at 20° C. at 100 s⁻¹ using a rotary viscometer. They have a good stability over time. No precipitation, creaming or change in taste or color was observed over time. Table 1 below summarizes the key elements of these examples.

TABLE 1
Profiles of Examples A, B, C and D according to the disclosure

| | Unit | A | B | C | D |
|---|---|---|---|---|---|
| Energy | kcal/100 mL | 250 | 250 | 250 | 250 |
| Proteins | g/100 mL | 14 | 16 | 18 | 14.4 |
| | % TEA | 22 | 26 | 29 | 23 |
| among which caseins | % by weight of proteins | 94 | 94 | 94 | 95 |
| among which serum proteins | % by weight of proteins | 6 | 6 | 6 | 5 |
| Fat | g/100 mL | 9.9 | 13.3 | 13.3 | 13.3 |
| | % TEA | 36 | 48 | 48 | 48 |
| Carbohydrates | g/100 mL | 26 | 16.5 | 14.5 | 18 |
| | % TEA | 42 | 26 | 23 | 29 |
| | glucose syrup DE | 29 | 29 | 29 | 29 |
| Water | % by weight of the composition | 55.5 | 57.8 | 57.8 | 56.3 |
| Viscosity | mPa · s at 100 s⁻¹ at 20° C. | 340 | <600 | <600 | 303 |
| Solids content | % by weight of the composition | 44.5 | 42.2 | 42.2 | 43.7 |
| Density | g/mL | 1.145 | 1.1 | 1.1 | 1.1 |

1. A ready-to-use heat-sterilized oral enteral nutritional composition comprising:
from 14 g to 20 g of proteins per 100 mL of the composition;
caloric density ranging from 1,046 kJ to 1,465 kJ (250 kcal to 350 kcal) per 100 mL of the composition;
a combined amount of fat, carbohydrates and proteins from 45 g to 72 g per 100 mL of the composition;
a solids content ranging from 40% to 65% by weight of the composition; and
an amount of water not exceeding 65% by weight of the composition.

2. The oral enteral nutritional composition according to claim 1, wherein the combined amount of fat, carbohydrates and proteins ranges from 45 g to 65 g per 100 mL of the composition.

3. The oral enteral nutritional composition according to claim 2, wherein the solids content ranges from 40% to 60% by weight of the composition.

4. The oral enteral nutritional composition according to claim 3, wherein the proteins provide at least 20% of the total energy intake.

5. The oral enteral nutritional composition according to claim 4, wherein the carbohydrates provide from 20% to 50% of the total energy intake.

6. The oral enteral nutritional composition according to claim 5, wherein the fat provides from 30% to 65% of the total energy intake.

7. The oral enteral nutritional composition according to claim 6, wherein the viscosity of the composition after heat sterilization ranges from 100 mPa·s to 600 mPa·s when measured at 20° C. at 100 s⁻¹ using a rotary viscometer.

8. The oral enteral nutritional composition according to claim 6, wherein the viscosity of the composition after heat sterilization ranges from 100 mPa·s to 450 mPa·s when measured at 20° C. at 100 s⁻¹ using a rotary viscometer.

9. The oral enteral nutritional composition according to claim 1, wherein the caloric density of the composition preferably ranges from 1,046 kJ to 1,256 kJ (250 kcal to 300 kcal) per 100 mL of the composition.

10. The oral enteral nutritional composition according to claim 1, wherein the protein comprises at least one source of casein and serum proteins.

11. The oral enteral nutritional composition according to claim 10, wherein the source of casein is selected from the list of ingredients consisting of MPIs, MPCs, MCIs, proteins of liquid condensed milk, skim milk, condensed skim milk, sodium caseinates, potassium caseinates, calcium caseinates or a mixture of at least two of the same.

12. The oral enteral nutritional composition according to claim 1, wherein the composition comprises less than 10% by weight of serum proteins based on the weight of the total protein.

13. The oral enteral nutritional composition according to claim 1, wherein at least 60% by weight of the carbohydrates based on the weight of the total carbohydrate content are provided by glucose syrup having a DE ranging from 20 to 40.

14. The oral enteral nutritional composition according to claim 1, wherein the oral enteral nutritional composition comprises:
from 14 g to 14.5 g of proteins per 100 mL of the composition;
about 1,046 kJ (250 kcal) per 100 mL of the composition;
a combined amount of fat, carbohydrates and proteins ranging from 45 g to 46 g per 100 mL of the composition;
a solids content ranging from 40% to 44.5% by weight of the composition;
an amount of water of less than 60% by weight of the composition; and
a viscosity of less than 450 mPa·s when measured at 20° C. at 100 s⁻¹ using a rotary viscometer.

15. The oral enteral nutritional composition according to claim 1, wherein the composition is intended to feed an elderly person, a malnourished person, a convalescent person or a person suffering from a chronic disease.

16. The oral enteral nutritional composition according to claim 1, wherein the combined amount of fat, carbohydrates and proteins ranges from 45 g to 65 g per 100 mL of the composition.

17. The oral enteral nutritional composition according to claim 1, wherein the solids content ranges from 40% to 60% by weight of the composition.

18. The oral enteral nutritional composition according to claim 1, wherein the proteins provide at least 20% of the total energy intake.

19. The oral enteral nutritional composition according to claim 1, wherein the carbohydrates provide from 20% to 50% of the total energy intake.

20. The oral enteral nutritional composition according to claim 1, wherein the fat provides from 30% to 65% of the total energy intake.
